(19) United States
(12) Patent Application Publication
(10) Pub. No.: US 2015/0048682 A1
(43) Pub. Date: Feb. 19, 2015

(54) DEVICE AND METHOD FOR HARVESTING, COLLECTING OR CAPTURING AND STORING AMBIENT ENERGY

(71) Applicant: RAFFE TECHNOLOGIES, INC., East Mountain (CA)

(72) Inventor: Alan Joseph Murley, East Mountain (CA)

(73) Assignee: RAFFE Technologies, Inc., East Moutain (CA)

(21) Appl. No.: 14/386,615

(22) PCT Filed: Mar. 28, 2013
(86) PCT No.: PCT/CA2013/000298

§ 371 Date: Sep. 19, 2014

(30) Foreign Application Priority Data
Mar. 30, 2012 (CA) 2772949

(51) Int. Cl. H02J 5/00; H02M 7/10; H02J 7/02; G05F 1/62; H02J 17/00; H02J 7/00

(52) U.S. Cl. CPC H02J 5/005; H02J 17/00; H02J 7/0055; H02J 7/025; G05F 1/62; H02M 7/10
USPC 307/52

(57) ABSTRACT

An ambient energy collector for use in AC/DC applications is described. The ambient energy collector has at least one ambient energy collecting antenna system and a master control unit for operational control of the at least one ambient energy collecting antenna system. The ambient energy collector has a DC voltage boosting circuit for increasing an input voltage, a DC primer power source for powering up the voltage boosting circuit via the input voltage, at least one antenna system for collecting ambient energy, an energy collection circuit for converting and amplifying an AC voltage collected by the antenna of the at least one antenna system into a DC voltage, and an output circuit for providing a load with the DC voltage.

### TECHNICAL FIELD OF THE INVENTION

The present invention relates generally to the harvesting, collecting or capturing of ambient energy and storing the energy for use in AC/DC applications. More particularly, the present invention relates to a multi-layer energy collection system and method for powering and/or charging electronic devices.

### BACKGROUND OF THE INVENTION

Energy harvesting devices have been known and used to capture and store energy in the form of electrical power for small autonomous devices such as, for example, wireless sensor devices and radio frequency identification (RFID) tags.

For example, it is known to use an antenna for radio frequency capture. The conventional devices use the antenna as input into a charge-pump circuit and then use the captured energy for powering other electronic circuits. Such a conventional device has been used in Radio Frequency Identification (RFID) applications. With an RFID system, a chip is inserted inside an RFID tag. When the control tag passes through a scanner device, power is sent to the chip from the scanner. Initially, RFID Tags were simple on/off circuits. In more recent systems, the chips are more complex and require more power to operate. As such, batteries are often deemed unsuitable for RFID systems because batteries will frequently become depleted and require charging before using.

For example, United States Patent Publication No. 2007/0107766 to Langley et al. describes an ambient electromagnetic energy collector which has a magnetic core of high permeability ferromagnetic material wrapped in an inductor coil for coupling primarily to a magnetic field component of a propagating transverse electromagnetic (TEM) wave. For coupling to electromagnetic waves of a wide range of frequencies and magnitudes, the collector is coupled to a multi-phase transformer connected to a multi-phase diode voltage multiplier to provide a current source output to an associated energy storage device. An output controller supplies output power as needed to the associated energy-using device. Preferred types of ferromagnetic materials include nickel-iron alloys with a small percentage of silicon, molybdenum, or copper. It may be combined with other types of ambient energy collectors, such as acoustic/vibration, thermoelectric, and photovoltaic collectors, in a multi-source device provided with a collector interface for converting the different outputs for storage in a common energy storage device. The multi-source ambient energy collector device can be used to supply power to embedded devices, remotely deployed wireless sensors or RFID tags, and other types of monitoring devices distributed over large areas or in industrial environments.

U.S. Pat. No. 6,765,363 to LaFollette describes an integrated micro power supply. In an exemplary embodiment, the micro power supply includes a microbattery formed within a substrate and an energy gathering device for capturing energy from a local ambient environment. An energy transforming device is also formed within the substrate for converting energy captured by the energy gathering device to electrical charging energy supplied to the microbattery.

U.S. Pat. No. 6,882,128 to Rahmel et al. describes a system and method for harvesting ambient electromagnetic energy, and more particularly, to the integration of antennas and electronics for harvesting ubiquitous radio frequency (RF) energy, transforming such electromagnetic energy into electrical power, and storing such power for usage with a wide range of electrical/electronic circuits and modules.

U.S. Pat. No. 7,084,605 to Mickle et al. describes a station having a means for receiving ambient energy from the environment and energizing power storage devices of objects of interest comprising one or more antennae and circuitry for converting said ambient energy into DC power for energizing said power storage devices. The circuitry for converting the ambient energy into DC power may include a rectifier/charge pump. The antenna of the station is tuned to maximize DC energy at the output of the rectifier/charge pump. The station can be used to energize power storage devices including capacitors and batteries that are used in electronic devices, such as cell phones, cameras, and PDAs. Various antenna constructions may be employed.

U.S. Pat. No. 7,400,253 to Cohen describes a system and device for harvesting various frequencies and polarizations of ambient radio frequency (RF) electromagnetic (EM) energy for making a passive sensor (tag) into an autonomous passive sensor (tag) adapted to collect and store data with time-stamping and some primitive computation when necessary even when an interrogating radio frequency identification (RFID) reader is not present (not transmitting). A specific source of ambient RF EM energy may include wireless fidelity (WiFi) and/or cellular telephone base stations. The system and device may also allow for the recharging of energy storage units in active and battery assisted passive (BAP) devices. The system could be a “smart building” that uses passive sensors with RF EM energy harvesting capability to sense environmental variables, security breaches, as well as information from “smart appliances” that can be used for a variety of controls and can be accessed locally or remotely over the Internet or cellular networks.

United States Patent Publication No. 2008/0084311 to Salzman describes an apparatus comprising: a substrate; an inductive element supported by the substrate, the inductive element having an inductance that is inherent; and magnetic material introduced to the substrate; wherein the magnetic material is sufficiently proximate to the inductive element so as to increase the inductance.

However, there are many major obstacles for capturing RF energy from the ambient environment. Energy harvesting is the gathering of transmitted energy and either using it to power a circuit or storing it for later use. The standard concept uses an efficient antenna and transmitter to transmit the energy over to an efficient receiver and a receiving antenna along with a circuit capable of converting alternating current (AC) voltage to direct current (DC) voltage. There are several drawbacks with this standard concept design in the prior art, which may be linked to the transmitter network and the receiver network. One goal in the design and operation of an antenna used for energy capturing is to match the impedance of each circuit. For example, it is known that if the two impedances are not matched, then there could be reflection of the power back into the antenna, meaning that the circuit was unable to receive all of the available power. To date, this kind of system generally requires a lot of maintenance to keep running, resulting in high associated costs. Also the conventional system is inefficient and known to generate very low output harvested energy.

By way of background, the following are several further drawbacks associated with conventional RF antennas which are known and have yet to be fully resolved by the conventional devices:
conventional RF antennas, in order to have maximum efficiency, require either a vertical or horizontal plane or both;
a conventional RF harvesting antenna is fixed, i.e. tunes to a specific RF frequency, e.g. 915 MHz;
conventional RF harvesting arrays are placed in a matching network, i.e. all the antennas are fixed and tuned to one RF frequency, e.g. 915 MHz;
a conventional RF harvesting system is a fixed system, to wit, a transmitter and receiver which are coupled together;
the transmitter sends a fixed frequency of 915 MHz to the receiver which has a fixed receiving value of 915 MHz (This is considered to be a one network system (binding) when the RF power is only transferred from the transmitter to the receiver);
conventional harvesting multi-array antennas are fixed to one band, e.g. a sample configuration: Antenna 1 is a locked band tuned to frequency 915 MHz, Antenna 2 is a locked band tuned to frequency 915 MHz, and Antenna 3 is a locked band tuned to frequency 915 MHz; and
the RF harvesting charge pump circuit is a fixed configuration matched to the network, e.g. charge-pump output value is DC 5 volts.

It would, thus, be desirable to use a multi-layer RF energy collection antenna and a variable charge-pump circuit in replacement of a standard charge-pump circuit. Thus, the antenna could deliver higher output power, which may be needed to power electrical circuits and require less servicing.

What is needed, therefore, is a receiving antenna and network that could self adjust the impedance of each network it is receiving a transmission from. Such a system would have a multi-layer antenna that could receive in all directions. Also the multi-layer antenna and system would be able to harvest RF energy from multiple energy sources and transmissions at the same time. This would result in low maintenance cost and higher harvesting output energy. Such a system should be easy to operate, while being relatively inexpensive to build and maintain.

### SUMMARY OF THE INVENTION

The present invention, thus, provides an antenna and a device for capturing and storing ambient energy.

Accordingly, as an aspect of the present invention there is provided a device for collecting ambient energy comprising at least one antenna system which comprises at least one antenna for collecting ambient energy, a primary start-up boost circuit for increasing an input voltage, at least one DC primer source for powering up the primary start-up boost circuit via the input voltage, an energy collection circuit for converting and amplifying an AC voltage collected by the antenna, a micro controller unit for operational control of the at least one antenna system, and an output for providing a load with a an output voltage.

Preferably, the antenna system further comprises an RF frequency sensor circuit for determining an optimum frequency for the at least one antenna to collect ambient energy.

Preferably, the antenna system further comprises a regulator recovery circuit for recovering an excess capacitance energy and via the micro controller unit provides the excess capacitance energy to the RF frequency sensor circuit and/or the energy collection circuit.

Preferably, the at least one DC primer source is a solar panel, a battery, a thermal device, and/or an AC to DC wall plug.

Preferably, the at least one antenna is tunable. Preferably, the tuning of the at least one antenna is provided by at least one variable capacitor and/or at least one programmable capacitor circuit. Preferably, the at least one antenna is a wire loop type antenna, a patch type antenna, an aperture type antenna, a micro strip type antenna, and/or a reflector type antenna. Preferably, each of the at least one antenna of each of the at least one antenna system have a same and/or different antenna type. Preferably, each of the at least one antenna system operates independently.

Preferably, the primary start-up boost circuit is a boost converter, a step-up converter, and/or a buck-boost converter circuit.

Preferably, the RF frequency sensor circuit is an RF detector.

Preferably, the energy collection circuit is a combination of a dickson charge pump and an AC to DC conversion circuit. Preferably, the energy collection circuit is a combination of a dickson charge pump and a rectifier circuit. Preferably, the energy collection circuit is a combination of a multi-stage charge pump circuit and an AC to DC conversion circuit. Preferably, the energy collection circuit is a combination of a multi-stage charge pump circuit and a rectifier circuit.

Preferably, the master controller unit is a programmable logic controller and/or a microcontroller.

Preferably, the load is a battery. Preferably, the load is an electronic device.

According to an embodiment of the present invention, there is provided an ambient energy collecting antenna. The antenna includes a DC voltage boosting circuit for increasing an input voltage, a DC primer power source for powering up the voltage boosting circuit via the input voltage, at least one antenna for collecting ambient energy, an energy collection circuit for converting and amplifying an AC voltage collected by the at least one antenna into a DC voltage, and an output circuit for providing a load with the DC voltage.

Preferably, the ambient energy collecting antenna may include an RF Sensor circuit for determining a frequency having the highest power and tuning at least one of the antennas to the frequency having the highest power.

Preferably, the ambient energy collecting antenna can include a regulator recovery circuit for recovering excess capacitance energy lost to ground and providing decoupling between the ambient energy collecting antenna system and the load.

According to another embodiment of the invention, there is provided a device for collecting ambient energy. The device includes at least one ambient energy collecting antenna system as embodied herein for collecting ambient energy, and a master control unit for operational control of the at least one ambient energy collecting antenna system.

Preferably, the device for collecting ambient energy may include an energy storage device, such as a battery.

### BRIEF DESCRIPTION OF THE DRAWINGS

The invention will be further understood upon review of the following detailed description of the preferred embodiments of the present invention when taken in conjunction with the appended drawings, in which:

FIG. 1 is a flow chart of a six antenna system of an ambient energy collecting device according to an embodiment of the present invention;

FIG. 2 is a flow chart of an antenna system according to an embodiment of the present invention;

FIG. 3 shows an architectural layout of an antenna according to an embodiment of the present invention;

FIG. 4 shows different wire loop antenna configurations for use in an antenna system according to the present invention;

FIG. 5 shows an architectural layout of an extended antenna of the antenna in FIG. 3 according to a further embodiment of the present invention;

FIG. 5a shows architectural layout of a parallel antenna design and a stacked antenna design according to preferred embodiments of the invention;

FIG. 5b shows a Prior Art antenna tuning with variable capacitors;

FIG. 5c shows antenna tuning using programmable capacitors in accordance with an embodiment of the present invention;

FIG. 6 shows a primary start-up boost circuit according to an embodiment of the present invention;

FIG. 7 shows an RF sensor circuit according to an embodiment of the present invention;

FIG. 8 shows an energy collection circuit according to an embodiment of the present invention;

FIG. 9 shows a Prior Art energy collection circuit;

FIG. 10 shows a regulator recovery circuit according to an embodiment of the present invention;

FIG. 10a shows another regulator recovery circuit according to a further embodiment of the present invention

FIG. 11 shows a functional block diagram primary start-up boost circuit (PSUBC) chip for use with the primary start-up boost circuit of FIG. 6 according to an embodiment of the present invention;

FIG. 12 shows a functional block diagram of cascaded RF detectors and limiters chip for use with the RF frequency sensor circuit of FIG. 7 according to an embodiment of the present invention;

FIG. 13 shows a functional block diagram of a programmable capacitor bank circuit for use with the energy collection circuit of FIG. 8 according to an embodiment of the present invention;

FIG. 14 shows exemplary multiple start-up boost configurations according to an embodiment of the invention;

FIG. 15 shows RF input impedance tests for the RF frequency sensor circuit; and

FIG. 16 shows simulation testing results of charge-pump stages with fixed capacitor value.

### DETAILED DESCRIPTION OF THE INVENTION

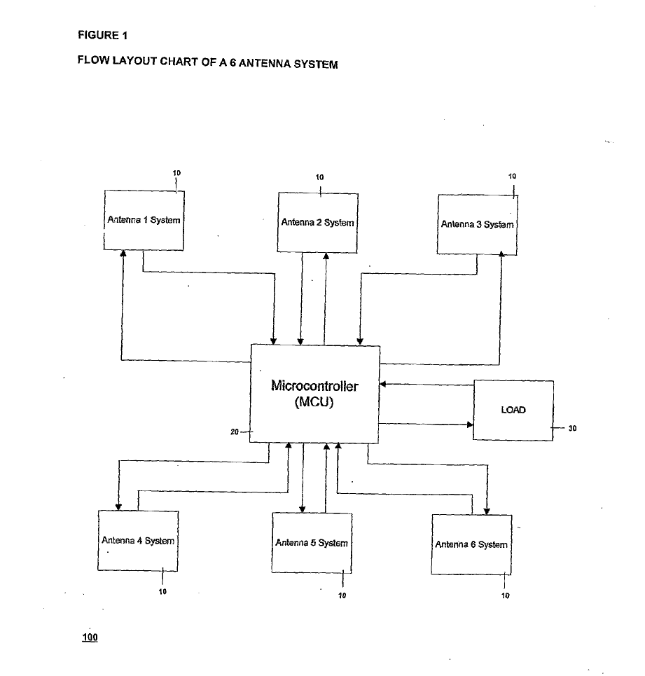

Referring now in more detail to the drawings, in which like numerals refer to like parts throughout the several views, FIG. 1 is a flow chart of a six antenna system of the ambient energy collector device 100 of the present invention. The ambient energy collector device 100 preferably includes a plurality of antenna systems 10 and a master controller unit 20. The master controller unit 20 may be connected to each antenna system 10 and to a load 30. In a preferred embodiment, the device may include six antenna systems 10. The antenna system 10 is also referred to as an Ambient RF Energy Power Cell.

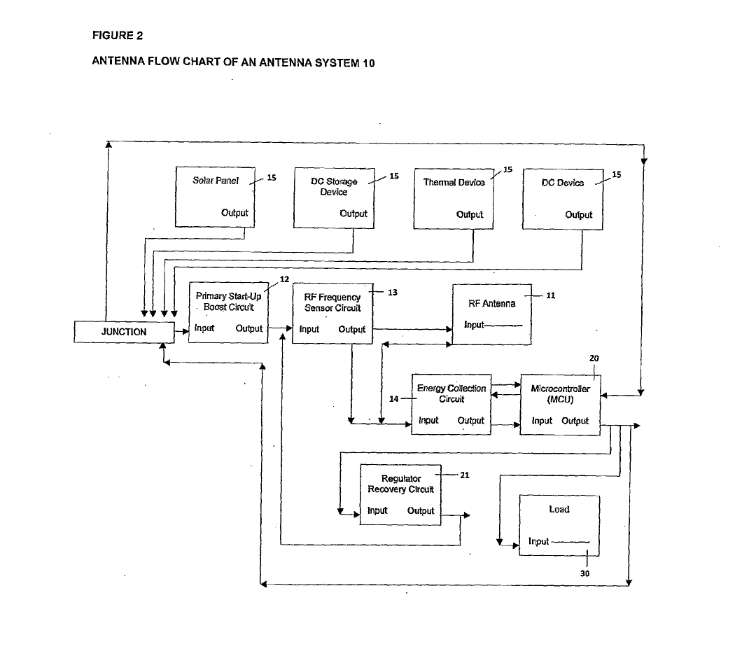

FIG. 2 shows a preferred embodiment of a flow chart of an antenna system an architectural arrangement of the circuitry that pertains to one of the layers of the antenna system 10. In the figures embodied herein, each block pertains to a circuit and the blocks are connected by arrows to show the input and output of each block.

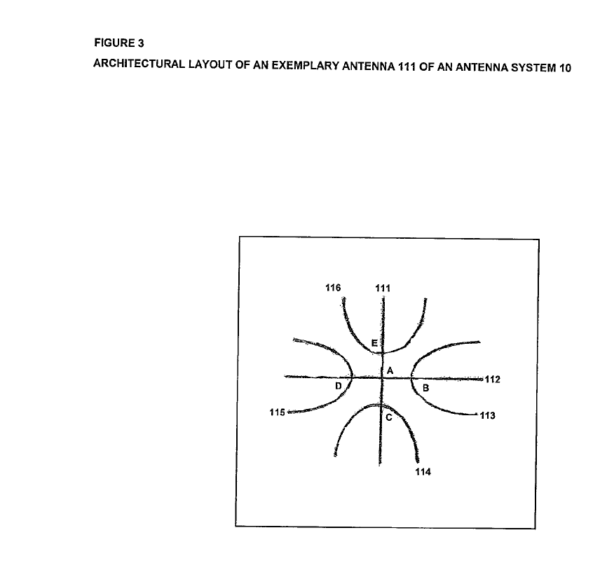

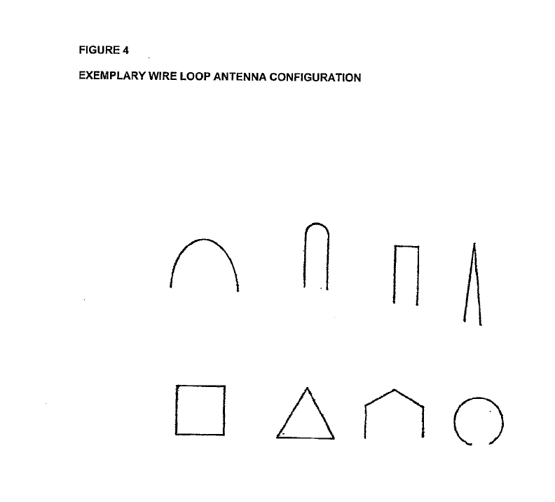

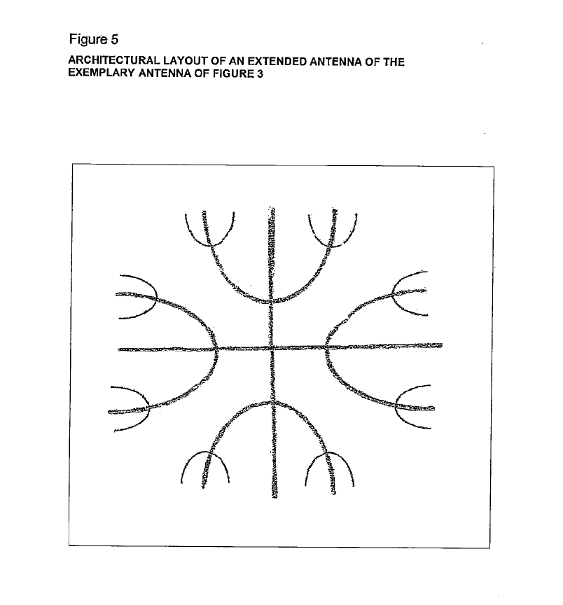

The invention is preferably implemented as a multi-layer design, which may be comprised of multiple antenna systems 10 that each act as an ambient energy harvester. For example, as embodied herein these can be labeled as antenna 1 system, antenna 2 system, antenna 3 system, antenna 4 system, antenna 5 system, and antenna 6 system, as show in FIG. 1. An exemplary embodiment of an antenna 11 used in each antenna system 10 is shown in FIG. 3.

According to a preferred aspect of the invention, the shape of the antenna elements may be geometrically designed to include, for example, flat-shaped, round-shaped, square-shaped, v-shaped, u-shaped layered materials. Exemplary wire loop antenna configurations are illustrated in FIG. 4.

Although preferred and described in detail herein are different wire loop antenna configurations, it should be understood that any type of antenna may be used for harvesting ambient energy, such as, for example, a patch antenna, an aperture antenna, a micro strip antenna, and a reflector antenna.

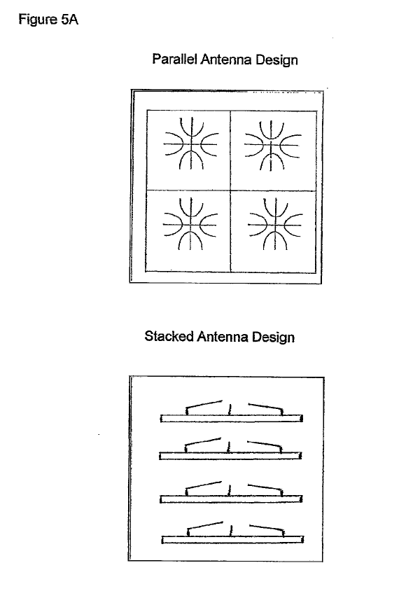

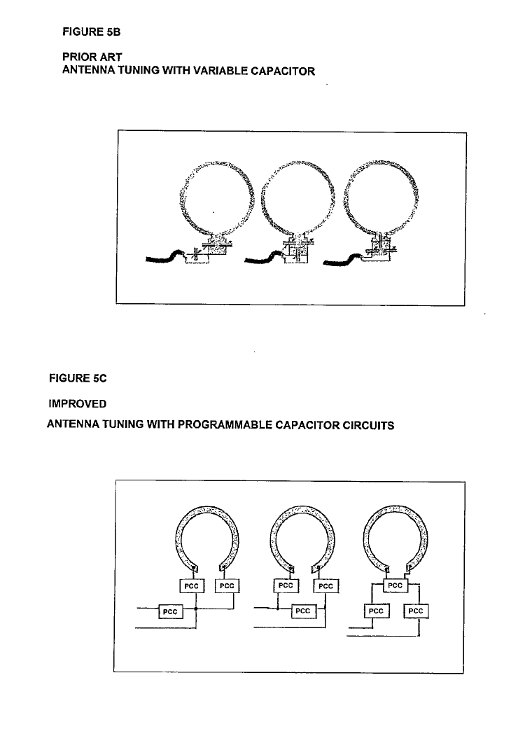

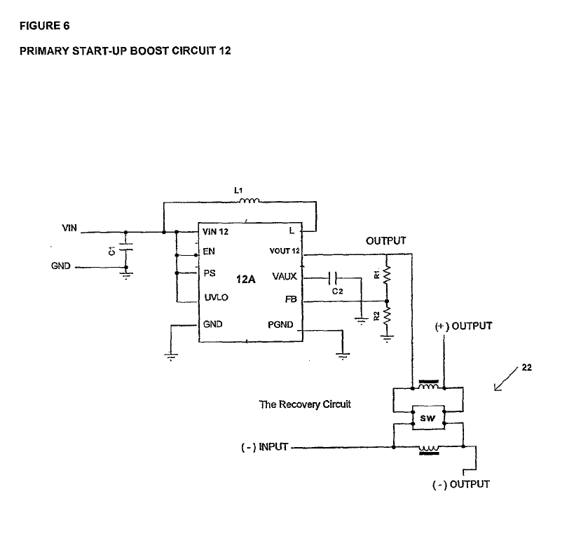

In FIGS. 3 and 5, exemplary architectural layouts of an antenna 11 are illustrated. In particular, for example, antenna element 111 is a straight metal conductor, antenna element 112 is a straight metal conductor with an inverted u-shaped bend antenna element 113, such as the half way point, which crosses over without contact with antenna element 111. As illustrated and designated herein, (A) is an area where antenna elements 111 and 112 overcross. Antenna element 113 as illustrated and embodied herein, can be curved or u-shaped. In another preferred embodiment, antenna element 113 may be v-shaped with the bottom of the ‘v’ being at the point where it crosses over antenna element 112. As illustrated and designated herein, (B) is an area where antenna elements 112 and 113 overcross. In accordance with the invention there is no contact between antenna element 111 and antenna element 113. In accordance with an embodiment of the invention, optimal performance may be obtained when the no-contact distance between antenna elements 111 and 112, and antenna elements 112 and 113 is substantially the same and/or the area (A) is substantially equal to area (B), as defined herein. Antenna elements 114, 115 and 116 may be designed similarly, as described above and illustrated herein for antenna element 113. For optimal performance areas A, B, C, D and E are substantially equal.

In accordance with a preferred embodiment of the invention, the antenna design can be extended either by adding more antenna elements as illustrated in FIG. 5 or by a parallel configuration or a stacking configuration as shown FIG. 5a. The antenna frequencies may be configured by the use of a programmable tuned antenna circuit, FIG. 5c. Alternatively, the antenna frequencies may be configured by using a variable capacitor with manual tuning, as is known in the art, FIG. 5b. The tuning range of the variable capacitors gives the antenna a frequency range of about 50 MHz to about 3 GHz.

Ambient RF Energy Power Cell (Antenna System 10)

Each antenna system 10 preferably includes an antenna 11 as described herein, a primary start-up boost circuit 12, an RF frequency sensor circuit 13, and an energy collection circuit 14.

The antenna 11 in each antenna system 10 may be of the same antenna type or a different type (e.g. wire loop, patch, etc.). The antenna 11 in each antenna system 10 may also be configured to the same section of the electromagnetic (EM) spectrum or different sections (e.g. high frequency, ultra high frequency, etc.). An ambient energy collector device 100 having antenna systems 10 of the same type and the same EM configuration may be used advantageously in areas where a dominant EM signal is present. An ambient energy collector device 100 having antenna systems 10 of different types and different EM configurations may be used advantageously in areas where no single dominant EM signal is present or in areas where a dominant EM signal varies over time. Other configurations of antenna systems 10 for an ambient energy collector device 100 may be used to suit the specific EM signal availability in areas of use.

Each of the antenna systems 10 may advantageously operate independently and tune to an EM signal that it (the antenna system 10) determines to be strongest.

Primary Start-Up Boost Circuit 12

A DC source of power 15 or primer input may be used to start the process of collecting ambient energy in accordance with a preferred embodiment of the invention. For example, the DC source of power may be, inter alia, a Solar, or a DC storage device.

In one particular embodiment, an initial power capable of starting and running the primary circuit is from about 0.15 μW to about 0.55 μW. The primary circuit may include a DC-DC boost conversion. Typically a harvesting energy circuit includes a voltage doubling circuit. For example, various forms of rectifiers which can take an AC voltage as input and output a doubled DC voltage are used and known. However, use of conventional harvesting of RF energy can produce only very small amounts of DC energy.

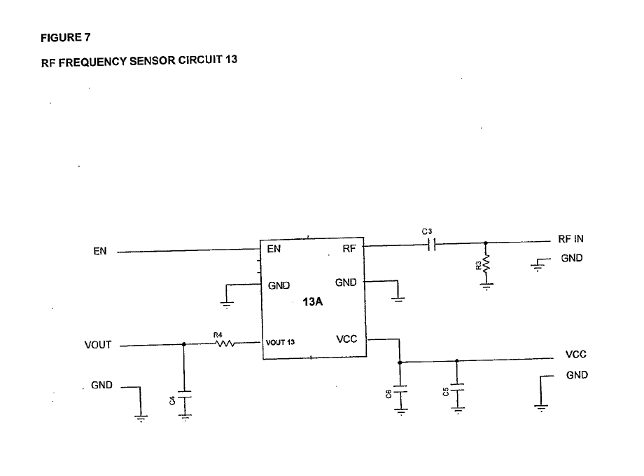

In accordance with the invention, as embodied herein and illustrated in FIG. 6 a primary start-up boost circuit includes a voltage boost circuit. For example, the voltage boost circuit of the invention can advantageously accept an input voltage of 0.01 DC volt and yield an output voltage of 5.5 DC and a maximum output current of 1500 mA. The output voltage can be applied to the RF frequency sensor circuit 13.

The primary start-up boost circuit 12 is more commonly known as a DC-DC conversion circuit, for the purposes of the present application a DC-DC conversion circuit wherein the output DC voltage is higher than the input DC voltage is preferable. The most preferable type of circuits to be used are known in the art as a boost converter, and a step-up converter. Another type of circuit than may be used to achieve this function is known as a Buck-Boost Converter circuit.

In FIG. 6, there is shown an inductor type boost circuit. The inductor L1 first charges when the switch (or an integrated chip) SW is closed. When the switch SW is open L1 discharges the voltage into the capacitor C2.

The primary start-up boost circuit 12 may receive an input source voltage from the external DC source, or internally from the master control unit 20 to start the process of collecting ambient energy. The primary start-up boost circuit 12 outputs (VOUT12) the boosted voltage to the RF frequency sensor circuit 13. The primary start-up boost circuit powers up the RF frequency sensor circuit 13.

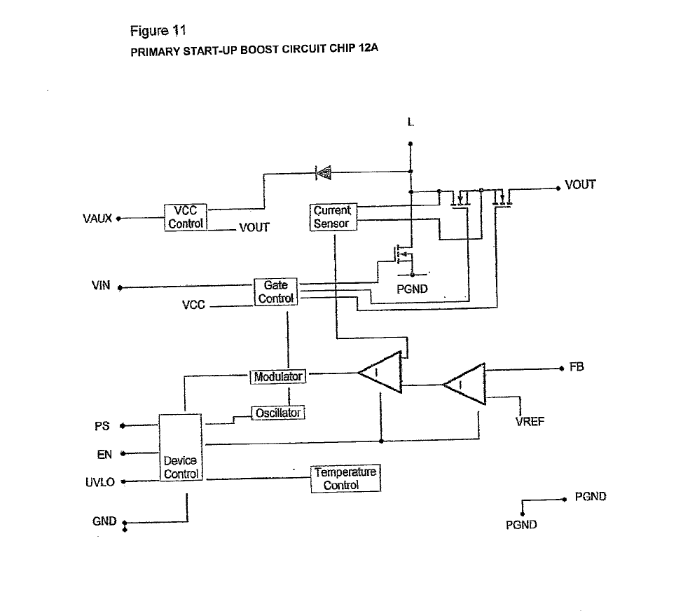

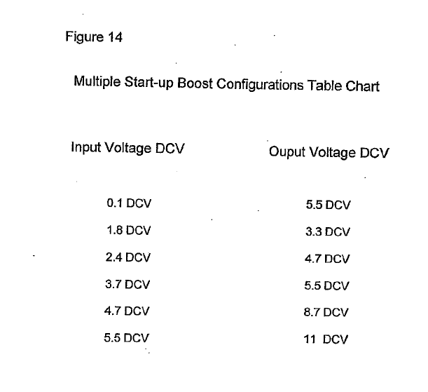

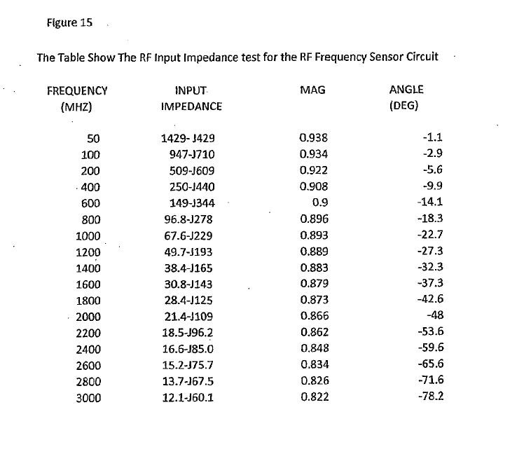

FIG. 11 shows a possible functional block diagram of a Primary Start-up Boot Circuit Chip 12A for use with the primary start-up boost circuit 12. FIG. 14 shows exemplary multiple start-up boost input/output DC voltage configurations according to an embodiment of the invention.

RF Frequency Sensor Circuit 13

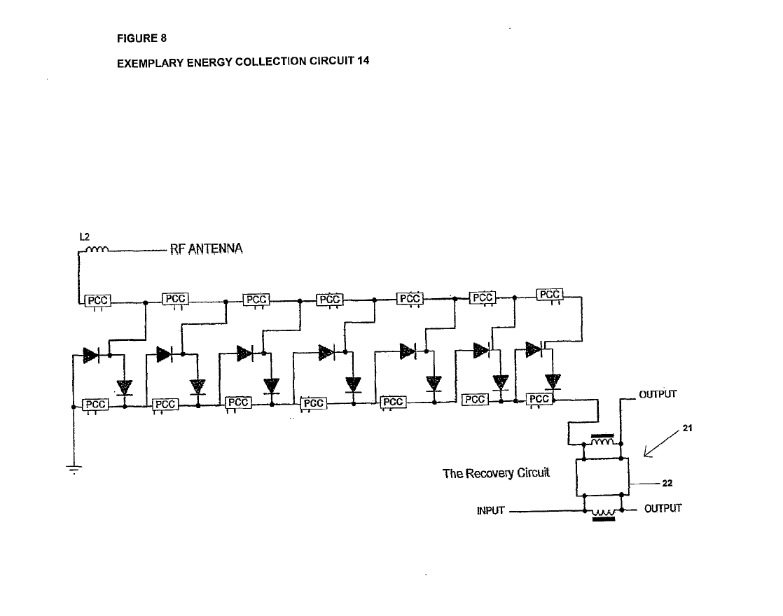

According to an embodiment of the invention, as illustrated in FIG. 7, the RF frequency sensor circuit 13 is capable of detecting RF signals transmitted by wireless transmitters. Advantageously, the RF frequency sensor circuit 13 is capable of detecting and measuring RF signals over a large dB dynamic range. For example, RF signal in a decibel scale can be precisely converted into a DC voltage. Preferably, a dB input dynamic range can be achieved by using cascaded RF detectors and RF limiters. Some of the example samples of the RF signals are: 50 MHz, 100 MHz, 200 MHz, 400 MHz, 600 MHz, 800 MHz, 1000 MHz, 1200 MHz, 1400 MHz, 1600 MHz, 1800 MHz, 2000 MHz, 2200 MHz, 2400 MHz, 2600 MHz and 3000 MHz. Some example of RF signal sources are: Bluetooth, Wlan, WIFI, GSM cell phone, FM Broadcast, UHF, VHF, and Broadband.

The RF frequency sensor circuit 13 can send a voltage to the antenna 11 and can receive a dB response from the antenna 11. The dB response is known as a reference scale. The RF frequency sensor circuit 13 can then convert the response into a DC voltage, FIG. 7. For example, the RF frequency sensor circuit 13 can receive from about 0.15 μW to about 7 mW of power to maintain the antenna system 10. The RF frequency sensor circuit 13 can maintain enough power to run itself and then send the surplus to the energy collection circuit 14. Preferably, the RF frequency sensor circuit 13 may recover EMF loss from the antenna systems 10 where it will later be converted into energy by the energy collection circuit 14.

The RF frequency sensor circuit 13 is more commonly known as an RF detector. RF detector circuits are used for measuring RF and IF signals, these types of circuits can generally be found in devices such as, for example, RF meters and cell phones.

The RF frequency sensor circuit 13 may receive an input source voltage from the primary start-up boost circuit 12. The RF frequency sensor circuit 13 output (VOUT13) may send a voltage to the antenna 11 to trigger a dB response and/or to the energy collection circuit 14.

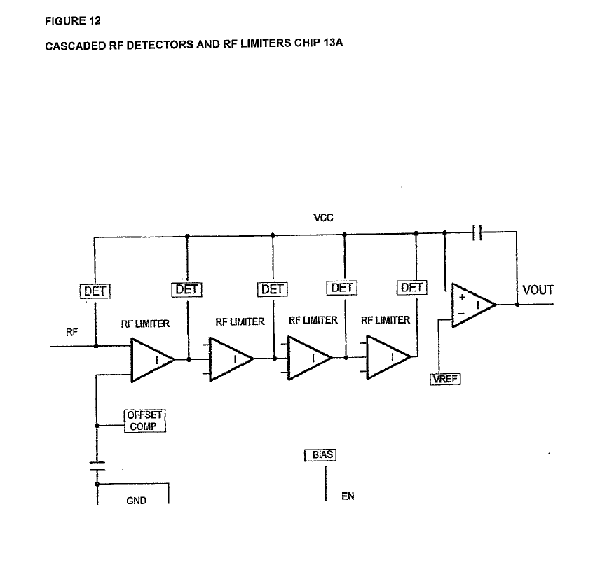

FIG. 12 shows a possible functional block diagram of a Cascaded RF Detector and RF Limiter Chip 13A for use with the RF frequency sensor circuit 13.

The Energy Collection Circuit 14

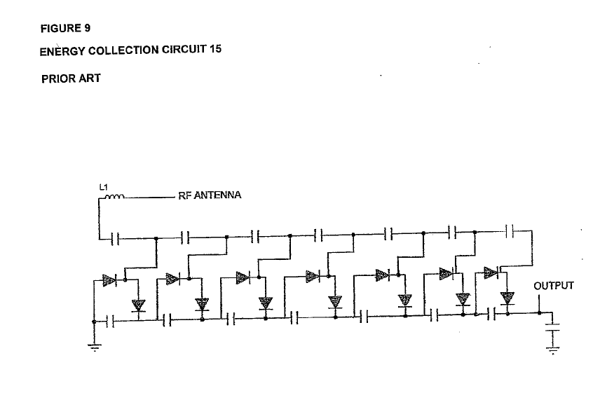

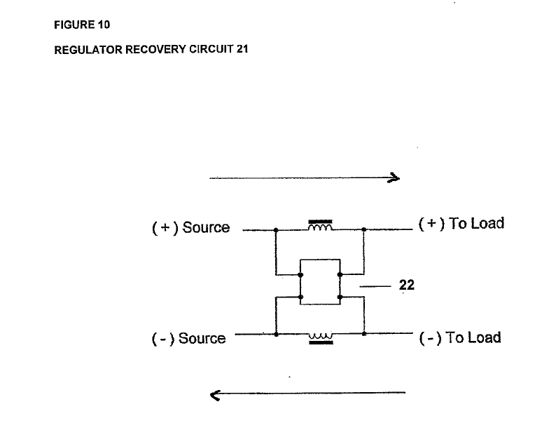

Typically, the energy collection circuit 14 is called a Charge Pump Circuit. Basically, the function of the charge pump circuit may be to double the effective amplitude of an AC input voltage and then to convert the energy to a DC voltage on an output capacitor, or a rechargeable battery, or a load. A conventional energy collection circuit 14 with standard capacitors is shown in FIG. 9. The conventional circuit includes fixed capacitors, with fixed capacitance values.

FIG. 8 shows a preferred configuration of an energy collection circuit 14 having programmable capacitor circuits, denoted as PCC.

Advantageously, according to an embodiment of the present invention, there is provided an auto stage charge pump circuit, which preferably is not fixed to one stage or one capacitor value. Thus, the energy collection circuit 14 according to an embodiment of the present invention includes a multi-stage charge pump circuit. Preferably, the charge pump circuit may comprise multiple configuration stages resulting in a wider range of output DC voltages. Having variable capacitors or adjustable capacitors or fixed array capacitors and auto multiple configuration stages can result in a wider range of DC output voltages, FIGS. 8 and 9.

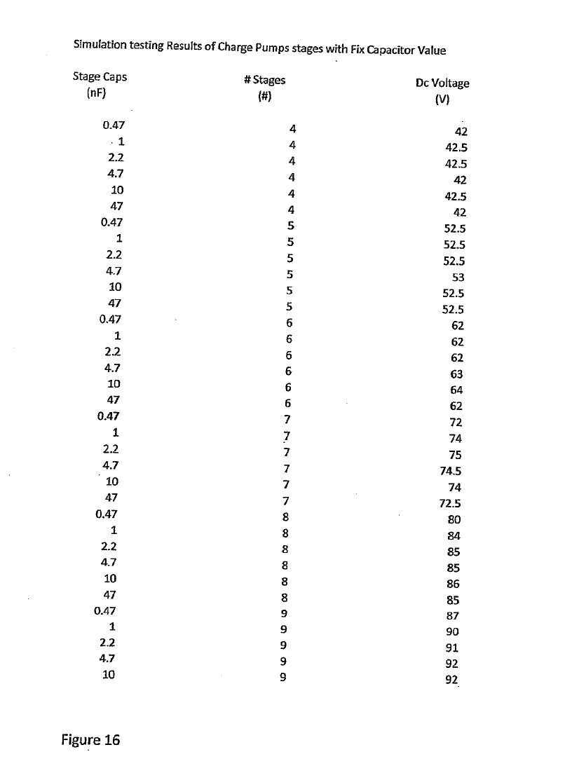

Referring to FIG. 16 which shows a typical simulation testing results of charge pump circuit stages with fixed capacitor values, it can be seen that with output capacitance the value of the capacitor only affects the speed of the transient response. The bigger the value of the output capacitance is the slower the voltage rise time. Small capacitance output values will cause rises in the rise time. In accordance with an embodiment of the invention, it may be advantageous to include an auto adjustment over charge pump stages and capacitors, which can result in a wider range of DC voltage output.

The basic function of the energy collection circuit 14 is to take a DC voltage from the RF frequency sensor circuit 13 and amplify it. The energy can be either stored or sent to the master controller unit (MCU) 20, which is described below in further detail.

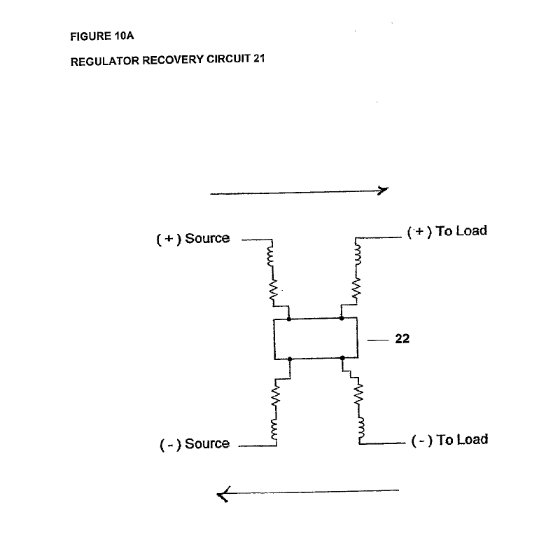

Referring now to FIG. 10, included in the energy collection circuit 14 is a regulator recovery circuit 21. The regulator recovery circuit 21 can act as an overflow capacitor circuit. Its primary function is to recover any excess capacitance energy that is normally lost to ground. The regulator recovery circuit 21, by way of a programmable logic controller, either outputs the energy back into the energy collection circuit 14 or outputs the recovered energy into the RF frequency sensor circuit 13 to assist with its power requirements.

The function of the regulator recovery circuit 21 is not only to store energy, but also to filter out noise and ripple, and to provide decoupling between the power supply and the load. The RRC capacitor 22 of the regulator recovery circuit 21 can be specially constructed to allow the DC load current pass through the RRC capacitor 22. The DC load output can go through a By-Pass Ferrite Core Winding, FIGS. 10 and 10a. According to FIG. 10a the regulator recovery circuit can use both inductors and resistors.

According to an embodiment of the invention, the energy collection circuit 14 may further include a programmable logic controller which controls the shut-off for the primary start-up boost circuit 12, this programmable logic controller may be separate from the master controller unit 20 or it may a part of the master controller unit 20. If the required voltage is achieved then the control will shut off the primary start-up boost circuit 12. If the value of the voltage drops below the desired value then the control will turn on the primary startup boost circuit 12.

The energy collection circuit 14 may be a combination of a Dickson Charge Pump and an AC-DC conversion circuit. A common term for an AC-DC conversion circuit is a rectifier circuit. FIGS. 8 and 9 show different embodiments of a Dickson Charge Pump circuit. A Dickson Charge Pump essentially comprises only diodes, capacitors, and a clock signal. In a preferred embodiment the Dickson Charge Pump comprises diodes, programmable capacitor circuits, and a clock signal supplied by the master controller unit 20. The efficiency of this type of circuit is near unity so it is not a limitation of powering a load. The Dickson Charge Pump circuit can also be referred to as a multi-stage charge pump circuit. The multi-stage charge pump circuit may have more or less than 7 stages and is not limited to 7 as depicted in FIGS. 8 and 9. Internally, the capacitors and diodes may have an external clock known as transfer rate time.

The energy collection circuit 14 may receive an input source voltage from the output (VOUT13) of the RF frequency sensor circuit 13 and the antenna coupling capacitor on the positive side of the antenna. The energy collection circuit 14 output (OUTPUT14) may be connected to the input of the micro controller unit 20.

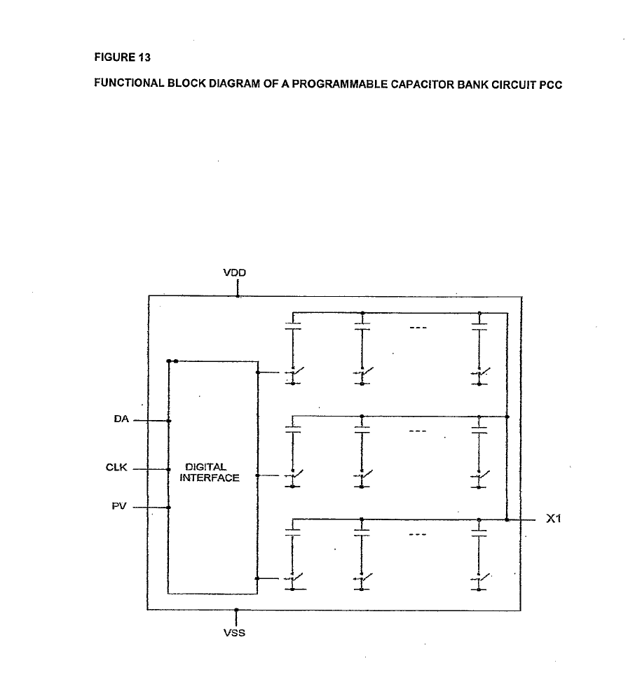

FIG. 13 shows a possible functional block diagram of a Programmable Capacitor Bank Circuit 14A for use with the energy collection circuit 14.

The Master Controller Unit 20

Preferably, according to an embodiment of the present invention, each antenna system (or layer) 10 of the ambient energy collector device 100 may include an antenna 11, a primary start-up boost circuit 12, an RF frequency sensor circuit 13, and an energy collection circuit 14. The energy collection circuit 14 from every array of the antenna may be connected to a master controller unit 20, as embodied herein and illustrated in FIG. 1.

Preferably, the master controller unit 20 may control each energy collection circuit 14 of each antenna system 10. More preferably, the master controller unit 20 may determine what energy is required to run a load 30 and/or may determine the sum of the harvested energy collected by all of the available antenna systems 10. According to a preferred embodiment, the master controller unit 20 may only harvest the energy required as determined by the master controller unit 20. For example, in operation, the master controller unit may start with one antenna system 10 and determine its potential harvesting energy value. If the amount satisfies energy requirements of the load 30 the master controller unit 20 may stop there and the load 30 runs off the harvesting potential of the one antenna system 10. If the harvesting potential of one antenna system 10 is not enough to run load 30 the master controller unit 20 may use a second and/or a third, etc., antenna system 10 until the required energy to run the load 30 is achieved.

The master controller unit 20 may be a programmable logic controller, a microcontroller, or the like. Preferably, the controller is one designed to be used in the field of energy harvesting and have low power consumption. Examples of commercially available controllers are available from PIC Industries™, Texas Instruments™, Freescale™, and Microchip™.

Variations, adaptations, and modifications to the preferred embodiments of the invention described above are possible without departing from the scope and essence of the invention as described in the claims appended hereto.

### LIST OF REFERENCE CHARACTERS AND NUMERALS

10 Antenna System;
11 Antenna;
12 Primary Start-Up Boost Circuit;
12A Primary Start-Up Boost Circuit Chip;
13 RF Frequency Sensor Circuit;
13A Cascaded RF Detector and RF Limiter Chip
14 Energy Collection Circuit;
14A Programmable Capacitor Bank Circuit
15 DC Source or Primer;
20 Master Controller Unit;
21 Regulator Recovery Circuit;
22 RRC Capacitor;
30 Load;
C1, C2, C3, C4, C5, C6 Capacitors;
EN Enable Input;
FB Voltage Input Feedback;
GND Ground;
L Connection Input for Inductor;
L1, L2, L3 Inductors;
PCC Programmable Capacitor Circuit;
PGND Power Ground;
PS Enable/Disable Power Save Mode;
R1, R2, R3, R4 Resistors;
RF Antenna Input;
SW Switch;
UVLO Under Voltage Comparator Input;
VAUX Supply Voltage for Control Stage;
VCC Power Supply Input;
VIN12 Primary Start-Up Boost Circuit Input Voltage;
VOUT12 Primary Start-Up Boost Circuit Output; and
VOUT13 RF Frequency Sensor Circuit Voltage Out.

### INDUSTRIAL APPLICABILITY

The present invention is applicable to the technical field of powering and/or charging electronics or energy storage.

The embodiments of the present invention in which an exclusive property or privilege is claimed are defined as follows:

1. A device for collecting ambient energy comprising:
at least one antenna system (10) comprising:
at least one antenna (11) for collecting ambient energy,
a primary start-up boost circuit (PSUBC) (12) for increasing an input voltage,
at least one DC primer source (15) for powering up the primary start-up boost circuit (12) via the input voltage, and
an energy collection circuit (ECC) (14) for converting and amplifying an AC voltage collected by the antenna (11),
a master controller unit (20) for operational control of the at least one antenna system (10), and
an output for providing a load (30) with an output voltage.

2. The device according to claim 1, wherein the antenna system (10) further comprises an RF frequency sensor circuit (RFFSC) (13) for determining an optimum frequency for the at least one antenna (11) to collect ambient energy.

3. The device according to claim 1, wherein the antenna system (10) further comprises a regulator recovery circuit (21) for recovering an excess capacitance energy and via the micro controller unit (20) provides the excess capacitance energy to the energy collection circuit (14).

4. The device according to claim 1 or 2, wherein the antenna system (10) further comprises a regulator recovery circuit (21) for recovering an excess capacitance energy and via the micro controller unit (20) provides the excess capacitance energy to the RF frequency sensor circuit (13) and/or the energy collection circuit (14).

5. The device according to any one of claims 1 to 4, wherein the at least one DC primer source (15) is a solar panel, a battery, a thermal device, and/or an AC to DC wall plug.

6. The device according to any one of claims 1 to 5, wherein the at least one antenna (11) is tunable.

7. The device according to claim 6, wherein the tuning of the at least one antenna (11) is provided by at least one variable capacitor and/or at least one programmable capacitor circuit (PCC).

8. The device according to any one of claims 1 to 7, wherein the at least one antenna (11) is a wire loop type antenna, a patch type antenna, an aperture type antenna, a micro strip type antenna, and/or a reflector type antenna.

9. The device according to any one of claims 1 to 8, wherein each of the at least one antenna (11) of each of the at least one antenna system (10) have a same and/or different antenna type.

10. The device according to any one of claims 1 to 9, wherein each of the at least one antenna system (10) operates independently.

11. The device according to any one of claims 1 to 10, wherein the primary start-up boost circuit (12) is a boost converter, a step-up converter, and/or a buck-boost converter circuit.

12. The device according to any one of claims 1 to 11, wherein the RF frequency sensor circuit (13) is an RF detector.

13. The device according to any one of claims 1 to 12, wherein the energy collection circuit (14) is a combination of a dickson charge pump and an AC to DC conversion circuit.

14. The device according to any one of claims 1 to 12, wherein the energy collection circuit (14) is a combination of a dickson charge pump and a rectifier circuit.

15. The device according to any one of claims 1 to 12, wherein the energy collection circuit (14) is a combination of a multi-stage charge pump circuit and an AC to DC conversion circuit.

16. The device according to any one of claims 1 to 12, wherein the energy collection circuit (14) is a combination of a multi-stage charge pump circuit and a rectifier circuit.

17. The device according to any one of claims 1 to 16, wherein the master controller unit (20) is a programmable logic controller and/or a microcontroller.

18. The device according to any one of claims 1 to 17, wherein the load (30) is a battery.

19. The device according to any one of claims 1 to 17, wherein the load (30) is an electronic device.
